(19) United States
(12) Patent Application Publication
(10) Pub. No.: US 2009/0138374 A1
(43) Pub. Date: May 28, 2009

(54) DISTRIBUTED FULFILMENT SYSTEM

(75) Inventor: Andrew Cohen, Cottesloe (AU)

Correspondence Address: WOODCOCK WASHBURN LLP, CIRA CENTRE, 12TH FLOOR, 2929 ARCH STREET, PHILADELPHIA, PA, 19104-2891, US

(73) Assignee: ACEINC PTY LIMITED, West Perth (AU)

(21) Appl. No.: 12/366,541

(22) Filed: Feb. 5, 2009

Related U.S. Application Data
(63) Continuation of application No. 10/150,372, filed on May 17, 2002, now abandoned.
Application No. 10/150,372 is a continuation of application No. PCT/AU01/01362, filed on Oct. 22, 2001.

(30) Foreign Application Priority Data
Oct. 20, 2000 (AU) PR 1019

(51) Int. Cl. G06Q 30/00

(52) U.S. Cl. 705/26

(57) ABSTRACT

A distributed fulfilment system is disclosed. A provider facilitates a matching service between a sender of goods and a set of potential couriers. In some embodiments a reverse auction is conducted between eligible couriers, with the lowest bidder being awarded the job at the second lowest price.

### CROSS-REFERENCE TO RELATED APPLICATIONS

This application is a continuation of U.S. patent application Ser. No. 10/150,372 filed May 17, 2002, which is a U.S. National Phase filing of PCT/AU01/01362 filed Oct. 22, 2001, which claims priority to Australian Patent Application No. PR 1019 filed Oct. 20, 2000, the entire contents of which are hereby incorporated by reference in their entireties.

### TECHNICAL FIELD

The invention pertains to delivery fulfilment systems and more particularly to a distributed fulfilment system which may include a reverse auction which establishes a courier delivery price.

### BACKGROUND

Current method for delivering physical goods include the utilisation of courier services. In most instances, a business or individual utilises the services of a single courier or a small set of pre-selected couriers.

It is also true that the movement of individuals and vehicles within any particular area includes a certain capacity for moving goods, which capacity is underutilised. This latent capacity to move goods is unutilised or underutilised because,
(a) senders of goods have no capacity to tap into delivery resources; and conversely
(b) possessors of spare delivery capacity have no capability to contact potential senders of goods.

### SUMMARY

The present invention proposes a solution to the wastage associated with under utilised physical transport.

The invention also proposes a method for disaggregating the business of courier delivery in such a way that delivery capacity is effectively distributed across a broader cross-section of society than merely the community of professional couriers.

The present invention also proposes means of making the courier delivery business more efficient by allowing participants to enter and exit the service supply chain according to their individual needs.

In order to effectuate the objects of the present invention methods are required for facilitating the interaction between senders and couriers.

Accordingly there are provided methods for providing the services of a courier.

In one embodiment of the invention, a provider facilitates a matching service as between a sender and a set of couriers. The provider allows the sender to select a freight specification and pick-up and delivery specifications, from which the sender constitutes an order. The provider also enables one or more couriers to post bonds and submit profiles from which the provider can match a courier to a sender in respect of a delivery of goods.

In other embodiments, the provider enables a sender to conduct a reverse auction between a sender and one or more couriers.

In some embodiments, couriers bid a price at which they will promise to fulfil an order. The provider arranges the auction and the display of the auction process to the participants so that a successful courier bidder will receive compensation from the sender which represent the next lowest bid, not the lowest bid.

Similarly it will be appreciated that the system has been disclosed with reference to a particular application, the reverse auction of courier services. It will be understood that the methods proposed by the present invention may be applied generally to the supply of goods or services. In the case of goods, subsidiary vendors can use the same bidding mechanism and methods to supply goods directly to, or on behalf of a primary vendor with whom the purchaser deals directly. In such a system the primary vendor takes a form of commission and avoids holding inventory.

### BRIEF DESCRIPTION OF THE DRAWINGS

FIG. 1 is a flow chart illustrating one embodiment of the present invention;

FIG. 2 is a schematic diagram illustrating certain aspects of pick up distance, corridor distance and delivery distance;

FIG. 3 is a flow chart illustrating another embodiment of the invention; and

FIG. 4 illustrates another refinement of the invention.

### DETAILED DESCRIPTION OF ILLUSTRATIVE EMBODIMENTS

### 1. Introduction

The following description discusses and illustrates a distributed fulfilment system (“DFS”) as it applies to a courier service. It will be understood that the same principals, methods and functions described below are equally applicable to a reverse option for the supply of goods or services and not merely their delivery. It will also be appreciated that the description provided illustrates the implementation of the invention in an internet environment. It will be appreciated that in this context the internet service merely is a communications medium and that other communications media may be suitable for delivering the information which is required to effectuate the invention. In particular, the methods of the invention may be implemented using only a wireless telephone or other wireless network with (at least) text messaging capability.

### 2. System Description

### 2.1 Purpose

The purpose of a distributed fulfilment system or DFS is to act as a broker between merchants who have goods they want delivered and couriers who are prepared to deliver these goods. Merchants enter jobs into the system and then couriers who have pre-registered their interest in jobs of that type are invited to bid for the job with the lowest priced courier being awarded the job.

The following sub-paragraphs describe the general characteristics of a delivery job, the filter used by couriers to indicate their interest in a job, the auction process and the financial processes of the DFS. The purposes of these sub-sections are to describe the general workings of the system and identify key data requirements.

### 2.2 Job Specification

The job specification is used by the merchant to describe the pick up and delivery job that they wish a courier to perform. It includes details of the goods and their pick up and delivery details. It is anticipated that many of the fields in the job specification will remain constant between jobs so that appropriate data (such as merchant name and address) will be automatically loaded upon job creation and will not require re-entry.

2.2.1 Job Status

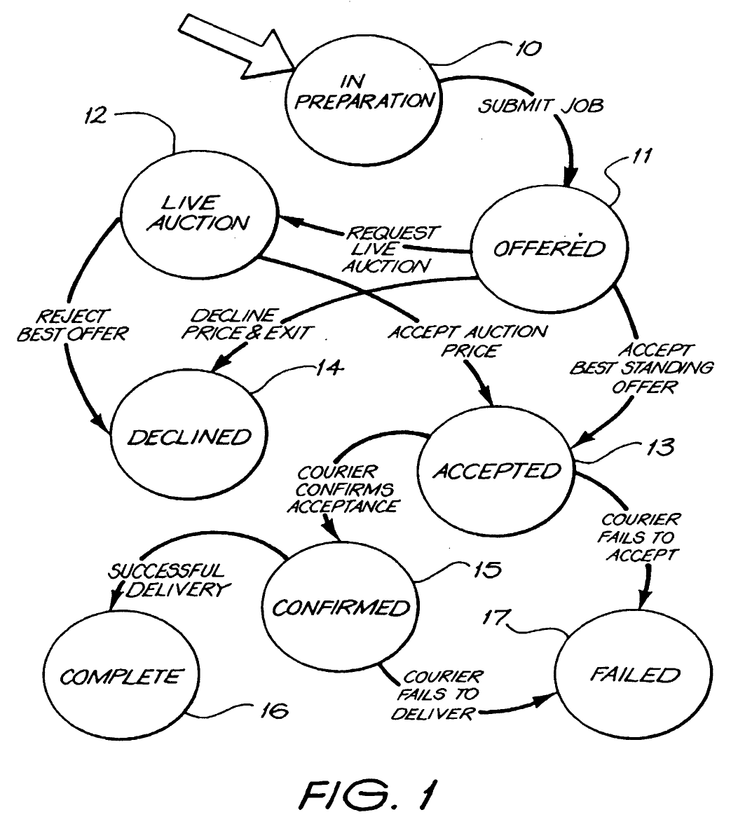

The status of each job in the system will be maintained and tracked so that merchants and system administrators can track each job to completion. The status of jobs will be one of the states given in Table 1. The relationship of the various states are illustrated in FIG. 1 using the reference numerals given in Table 1.

TABLE 1
Job Status States

| Status | Description |
|---|---|
| In Preparation (10) | Jobs that are currently being prepared by a |
| | merchant |
| Offered (11) | Jobs that have been submitted by the Merchant |
| | and are currently only being considered for |
| | Standing Offers |
| Auction (12) | Jobs that have been submitted by the Merchant |
| | and have had the Standing Offer rejected and are |
| | undertaking a Live Auction |
| Accepted (13) | Jobs that have been through a Standing Offer and |
| | possibly a Live Auction and have returned a price |
| | that is acceptable to the merchant who has |
| | decided to use the successful courier |
| Declined (14) | Jobs that have been through a Standing Offer and |
| | possibly a Live Auction and have returned a price |
| | that is unacceptable to the merchant who has |
| | decided not to use any courier |
| Confirmed (15) | Jobs that have been accepted by a merchant and |
| | confirmed by a courier |

2.2.2 Freight Specification

Freight will be classified by a combination of, for example, four simple type codes, which will cover most simple goods shipped. These sample classifications are shown in Table 2 and it is anticipated that merchants will describe goods by selecting one of the fields for each of the four codes. In the case of more complex goods, a more complete description will be required and this is given in Table 3.

TABLE 2
Freight Codes

| Freight Type | Value | Largest Dimension | Weight |
|---|---|---|---|
| Simple | <$50 | largest dimension | <5 kg |
| | | 400 mm | |
| Perishable | <$100 | largest dimension | <10 kg |
| | | 600 mm | |
| Fragile | <$500 | largest dimension | <20 kg |
| | | 800 mm | |
| Live | <$1000 | largest dimension | <50 kg |
| | | 1000 mm | |
| Frozen | <$5000 | largest dimension | <100 kg |
| | | 1200 mm | |

TABLE 3
Complex Goods Freight Specification

| Characteristic | Units | Notes |
|---|---|---|
| Number of Items | Integer number | Number of items in |
| Dimensions | Length, Height and | goods |
| | Width (metres) | |
| Mass | Total Mass in Kilograms | |
| Description of Goods | Free Text Field | |
| Value of Goods | $ Australia | |
| Freight Type | One of fixed types | Need for administrator |
| | General | to simply extend list |
| | Fragile | |
| | Security | |
| | Live | |
| | Frozen | |
| | Perishable | |
| | Dangerous | |
| | Hazard Code | |

2.2.3 Number of Items

The delivery specification will identify the number of distinct items, of the type described by the freight specification in the delivery job.

2.2.4 Delivery Specification

The delivery specification provides all of the details of the pick up and delivery aspects of the job including contact names and phone numbers, addresses and suitable times for pick up and delivery. A sample specification is shown in Table 4.

TABLE 4
Delivery Specification

| Characteristic | Units | Notes |
|---|---|---|
| Merchant Name | Free Text Name | |
| Pick up Address | Conventional Address Format | |
| | Unit/Level Number | |
| | Street Number, Street Name | |
| | City | |
| | State | |
| | Country | |
| | Post Code/Zip | |
| Merchant Contact Phone | Conventional Phone Number | |
| Number | Area Code | |
| | Phone Number | |
| Acceptable Pickup Times | Standard Day and Time Matrix | |
| | Monday XX-XY, ZZ-UU | |
| | Tuesday XX-XY, ZZ-UU | |
| | Wednesday XX-XY, ZZ-UU | |
| | Thursday XX-XY, ZZ-UU | |
| | Friday XX-XY, ZZ-UU | |
| | Saturday XX-XY, ZZ-UU | |
| | Sunday XX-XY, ZZ-UU | |
| | Public Holidays XX-XY, ZZ-UU | |
| Customer Name | Free Text Name | |
| Delivery Address | Conventional Address Format | |
| | Unit/Level Number | |
| | Street Number, Street Name | |
| | City | |
| | State | |
| | Country | |
| | Post Code/Zip | |
| Customer Contact Phone | Conventional Phone Number | |
| Number | Area Code | |
| | Phone Number | |
| Latest Delivery Time | Date and Time | |
| | DD/MM/YY | |
| | HH:MM | |
| Acceptable Delivery Times | Standard Day and Time Matrix | |
| | Monday XX-XY, ZZ-UU | |
| | Tuesday XX-XY, ZZ-UU | |
| | Wednesday XX-XY, ZZ-UU | |
| | Thursday XX-XY, ZZ-UU | |
| | Friday XX-XY, ZZ-UU | |
| | Saturday XX-XY, ZZ-UU | |
| | Sunday XX-XY, ZZ-UU | |
| | Public Holidays XX-XY, ZZ-UU | |

2.2.5 Time to Close Auction

This is the time at which the live auction process will cease and the current bid will become the best bid available. It is entered by the merchant at the time they nominate to go to a live auction (either at job creation or when they reject the best standing offer bid and elect for a live auction).

2.2.6 Reserve Price

This is the price that the merchant will stop looking for a lower cost courier and accept the job. This price may be kept in secret.

2.2.7 Automatic Acceptance

To minimise the cost to the merchant of monitoring the auction process and accepting offers, a number of filters will exist that can be set at time of job creation. At least one of these filters must be selected. The options will be:

Notify of Offers
Present the outcomes of the standing offer pre-auction and any live auction to the merchant for acceptance or rejection. This is the default selection.

Always go to Live Auction
regardless of the outcome of the standing offer pre-auction, the job will always proceed to live auction. Note if this option is selected at job creation, the time to close auction must also be entered.

Terminate Auction at Reserve
if a best standing offer price is received, which is less than the reserve set, then accept that offer and don't go to a live auction. Otherwise go automatically to a live auction and once the bid price is lower than the reserve price, terminate the live auction and award the job to the courier with that bid.

Note that while the first option is mutually exclusive with the following two, any combination of these two options may be selected at the same time. Note that a reserve price must be entered if the last option is selected.

### 2.3 Courier Profile

Couriers will be able to enter any number of distinct profiles to describe the types of job that they are prepared to undertake. Each profile will describe the type of goods they are willing to deliver, the area they will operate in and the rates they will charge. Couriers wishing to operate in multiple areas or have different rates for different types of goods in common area will use multiple profiles. Profiles will have two states, Active and Deactivated. The DFS will store all profiles created by a courier but only Active profiles will be used in selecting eligible couriers. Couriers will be able to change the state of any of their profiles from Active to Deactivated and from Deactivated to Activated at will. Profiles that have not been active for some time (six months) will be automatically deleted from the system. Profiles may be used to “push” invitations to potentially interested couriers to participate in a live auction.

A profile preferably includes a location where the potential courier is located. This location information may be supplied by the courier manually. Manual location sending requires a potential courier to notify the DFS by web form, phone, fax etc. of their current location. In the alternative, the location information can be sent automatically from the potential courier to the DFS, for example from a cell based telecommunications device or GPS enabled device. In another alternative, location information is provided by the courier's network to the DFS. A cellular network can communicate this information to the DFS at the request or authorisation of the potential courier.

2.3.1 Type of Goods

As shown in Table 5, couriers will be able to nominate what type of goods they are prepared to carry. This will be compared to the job specification to determine which couriers are eligible for the job.

TABLE 5
Type of Goods to be Carried

| Freight Characteristic | Units |
|---|---|
| Mass of each good | Maximum weight in Kilograms |
| Maximum Dimensions of | Length, Width and Height in millimetres |
| each good | |
| Freight Type of goods | List of all types they will carry (see Table 3) |

2.3.2 Pickup/Delivery Specification

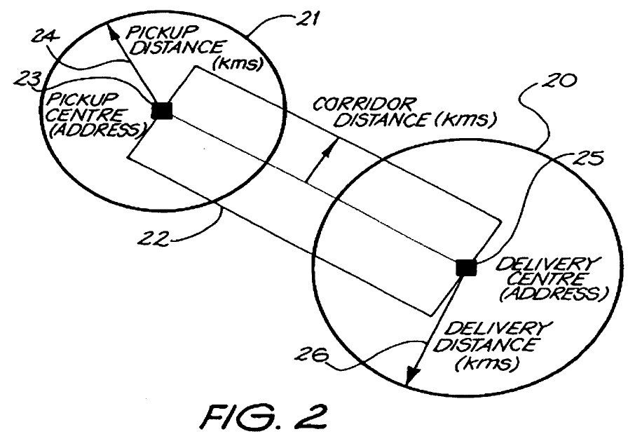

As shown in FIG. 2, a delivery 20 and pickup 21 region and a corridor 22 between these two regions will define the area in which the courier is prepared to operate. A central address 23 and a radius 24 in kilometres from this address will define the pick up region in which a courier is prepared to pick up goods. Similarly, the delivery region will be defined by a central address 25 and a radius 26 in kilometres from this address for which the courier is prepared to deliver goods. A transport corridor 22 between the pickup and delivery centres will also be defined as the distance from a straight line between these centres that the courier is prepared to both pickup and deliver goods.

2.3.3 Pickup Times

Couriers will specify, as shown in Table 6, the times that they are prepared to pick up goods on each of the seven days of the week and public holidays (eight possible types of day) for each of the possible delivery time categories.

TABLE 6
Pickup Time Specification

| | Monday | . . . etc | Public Holidays |
|---|---|---|---|
| <Three hours | 7:00 am-4:00 pm | 7:00 am-2:00 pm | — |
| Same Day | 7:00 am-2:00 pm | 7:00 am-11:00 am | — |
| Next Day | 7:00 am-7:00 pm | 7:00 am-11:00 pm | 5:00 pm-7:00 pm |
| Next Seven | 7:00 am-7:00 pm | 7:00 am-9:00 pm | 5:00 pm-7:00 pm |
| Days | | | |

2.3.4 Live Auction Participant

A data item will be maintained which indicates the couriers willingness (yes/no) to participate in live auctions for jobs matching this profile.

2.3.5 Standing Offers

A Standing Offer pricing model will be available for each profile. It will allow four types of delivery, less than three hours, same day, next day and next seven days. Couriers will be able to create their own pricing schedules based on the distance between pick up and delivery. This distance will be referred to as the Courier Distance. For each delivery time frame they will be able to define any number of Courier Distance intervals providing these are monotonic and continuous. In each delivery time frame and distance combination, the courier can nominate a starting price for bidding their services, a minimum price they will accept and an auction bid increment that will be used in the bidding process to bid for the job. An example is shown in Table 7. In this example the courier would for a same day Courier Distance of 15 kilometres participate in the auction with an opening bid $9.00 and bid down in increments of $0.50 to a minimum price of $7.00 before they would withdraw from the auction.

TABLE 7
Pricing Model Table

| | <10 kms | 10 to <20 kms | 20 to <30 kms |
|---|---|---|---|
| <Three hours | $10.00, $7.50, $0.50 | $12.00, $9.50, $0.50 | $15.00, $10.50, $0.50 |
| Same day | $9.00, $6.00, $0.50 | $9.00, $7.00, $0.50 | $9.00, $6.00, $0.50 |
| Next Day | $9.00, $5.00, $0.50 | $9.00, $6.00, $0.50 | $9.00, $5.50, $0.50 |
| Next Seven Days | $9.00, $5.00, $0.50 | $9.00, $5.00, $0.50 | $9.00, $5.00, $0.50 |

### 2.4 Auction Process

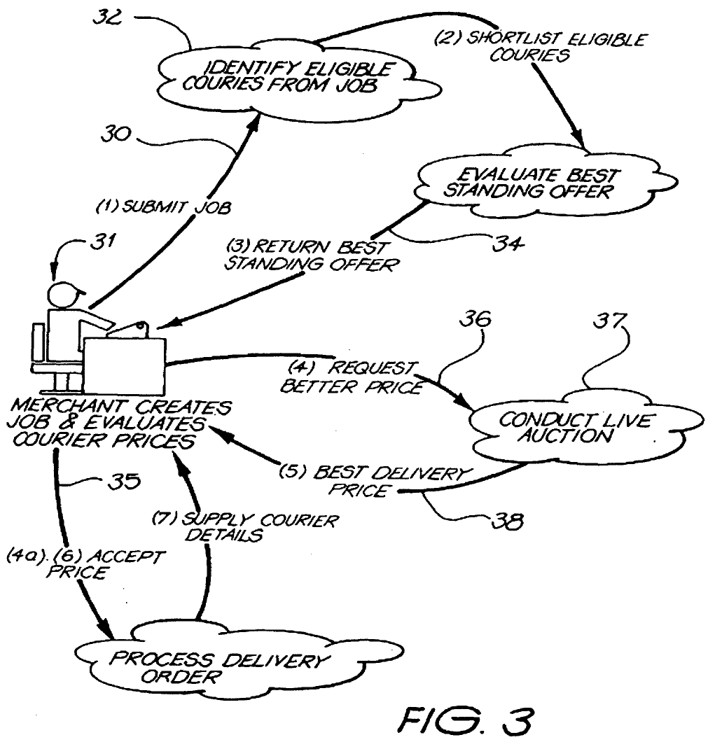

The auction process to determine the lowest price bid will be a two-stage process. Initially an auction will be held between those couriers who have submitted a standing offer for their services. The best price from this auction will be presented to the merchant for his consideration. Should the merchant wish to seek a lower price, then the process will proceed to a live auction. This process is shown in FIG. 3 and described below.

As shown in FIG. 3, once a job has been submitted 30 from a merchant 31, all the registered couriers who have lodged standing offers are searched 32 to identify those couriers whose job profiles match the submitted job, (see section 2.4.1). From this list, a pre-auction 33 will be held to determine the best standing offer, (see section 2.4.3). The price determined from the standing offer auction will then be returned 34 to the merchant 31 who can either accept 35 that price and give the job to the corresponding courier, request 36 a live auction 37 in an attempt to get a better price, or exit the system. All those registered couriers who have indicated that they will participate in live auctions are then searched to identify those couriers whose job profiles match the submitted job and a live auction 37 is conducted between these eligible couriers with the best Standing Offer as a starting point. Note that, even if the best standing offer courier does not elect to participate in live auctions they will be automatically included in the live auction to bid down to their minimum price at their nominated increments.

The auction process will terminate under one of two conditions, whichever is the first to occur. Either at a specified time nominated by the merchant at job creation, or if the merchant has nominated a reserve for the job, when the auction price falls below this price.

Once the live auction is complete, the best price (either from a live auction participant or the original standing offer if no better price has been subsequently obtained), will be submitted to the merchant. The merchant may then either accept that price and give the job to the corresponding courier or alternately reject the price and make their own delivery arrangements outside of the DFS.

If no eligible couriers with standing offers exist, then the merchant shall be notified of this and may choose to go to a live auction or exit the system. If no live auction bids are received, then the merchant will be notified that no couriers are available.

2.4.1 Auction Principles

The general principles of the auction are that prospective couriers will bid amongst themselves and the lowest priced offer will win. However, the price charged for the job will, in preferred embodiments, not be the lowest bid but the price of the next lowest bid. Thus if the lowest two bids offered are $4.50 by courier A and $4.25 by Courier B, then Courier B will win the job at a price of $4.50.

In the case of a reserve being applied to the Auction, where only the lowest price courier is below the reserve price, then that courier shall win the business at a price equal to the reserve price. Thus if the lowest two bids offered are say $4.50 by courier A and $4.25 by Courier B and a reserve price of $4.40 applies to the job, then courier B will win the job at a price of $4.40.

2.4.2 Identify Eligible Couriers

Only a sub-set of couriers will have profiles that match any particular job specification from a merchant, and only these couriers will be considered for that job. Eligible couriers shall be selected from the list of registered couriers who are currently logged onto the DFS by matching the job specification. Only those couriers with a complete match will become eligible.

The search precedence will be
filter the registered couriers who are logged onto the system by the Value of the goods and their bond limit,
filter the resulting matching couriers by the type of goods,
filter the resulting matching couriers by the pick up time, and
filter the resulting matching couriers by the pick up/delivery specification.

The registered couriers who match all four filters become the eligible couriers for that job.

Whilst only eligible couriers will be considered for standing offers and automatically invited to bid on jobs, any registered courier may search the DFS for Live Auction jobs where their bond limit exceeds the value of the goods.

2.4.3 Determine Distance Between Points

The distance between two addresses will be calculated through the use of an engine which will translate the addresses of each point into a set of universal coordinates. The distance between the two points will then be calculated as the great circle distance between the points plus 20% to allow for indirect routing.
Courier Distance shall be calculated between Pickup and Delivery addresses.
Pickup Distance shall be calculated between the Profile Centre and Pickup addresses.
Delivery Distance shall be calculated between the Profile Centre and Delivery addresses.

2.4.4 Pre Auction

All jobs shall be initially priced by reference to the standing offers from eligible couriers. This price will be determined by a reverse auction between the eligible couriers. In practice this will result in the job going to the eligible courier with the lowest minimum price standing offer, as seen by the merchant, for a price:
equal to the minimum price of the eligible courier with the next lowest minimum price, or
equal to its starting price if it is the only eligible courier with a standing offer.

If two or more eligible couriers have an identical lowest price, then the job shall be awarded to one of these eligible couriers at random for a price equal to their lowest price.

If no Standing Offers exist amongst the eligible couriers, then the merchant shall be advised and prompted to initiate a live auction.

2.4.5 Live Auction

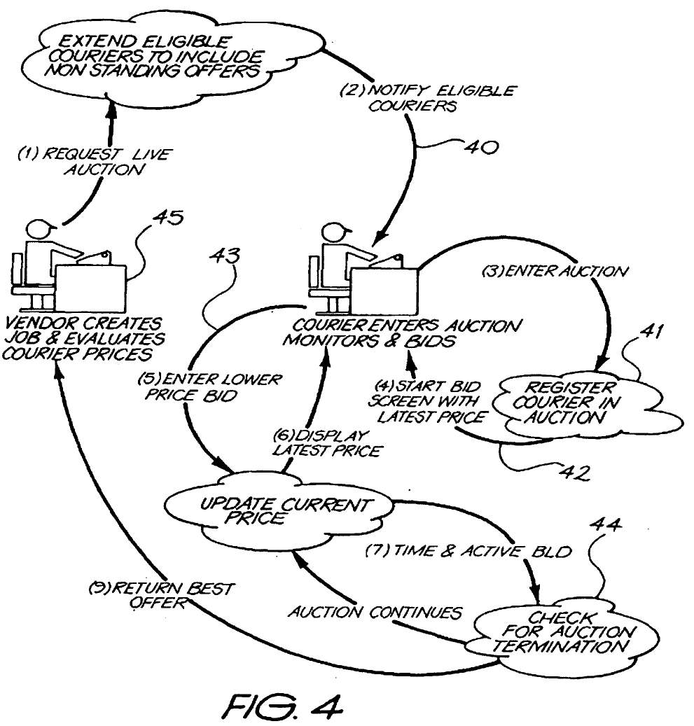

A live auction will be conducted between those registered couriers who have indicated their willingness to participate in live auctions and whose profile matches the job characteristics. The live auction process is shown in FIG. 4.

Each eligible courier will be invited 40 to join the auction by a notification from or initiated by a merchant or vendor 45 describing the job and advising of the existing standing offer as an opening price. (If no standing offer exists then the invitation shall indicate “NO BID”. Couriers who receive this invitation will be able to register 41 interest in the job. Once interest has been registered the courier will be able to view the current bid price in real time 42 and enter any bids 43. It is anticipated that couriers may be engaged in more than one auction simultaneously and so the interface with the courier must support registering in new auctions while participating in multiple auctions.

Registered couriers, whose profile does not completely match the job but whose bond is sufficient to cover the cost of goods will be able to participate in the live auction by registering interest in a particular job. This process will, however, require them to search all available jobs (with goods values less than their bond amount) and manually register for the auction.

The auction will be terminated 44 when either the time allowed for the auction expires or when bidding reaches the reserve price of the merchant.

The exception to the above is the courier who has evaluated to have the lowest standing offer. Even if the best standing offer courier does not elect to participate in live auctions they will be automatically included in the live auction to bid down to their minimum price at their nominated increments. If bidding goes below their lowest price then, if they have indicated their willingness to participate in live auctions they will be notified of the auction and invited to participate themselves. Otherwise their lowest bid has been beaten and the job will be awarded to a live auction participant. If they have indicated a willingness to enter into live auctions then their invitation for entry will still be delayed until after bidding has gone below their lowest standing offer.

2.4.6 Job Aggregation

When a merchant has more than one job in Live Auction Status with the same time to terminate the auction, the DFS may pool all of the jobs from the merchant and create a single aggregate job. Only those couriers whose profiles match all of the jobs in the aggregate will be invited to participate in the auction. Eligible couriers may then bid for the aggregate job as well as the individual jobs that comprise the aggregate. If at the completion of the auction the price of the aggregate job is less than the sum of the prices of each of the individual jobs that comprise the aggregate then all jobs in the aggregate shall be given to that courier. Otherwise each job may be individually awarded to its lowest priced courier.

### 2.5 Financial Process

2.5.1 Annual Fees

Each courier may be required to pay an annual fee to register on the DFS. The initial fee must be lodged at enrolment together with the initial bond. At each anniversary of enrolment a further amount equal to the annual fee may be deducted from any fees owed to the courier.

2.5.2 Merchant & Courier Displays

All financial figures displayed and entered by merchants and couriers will represent the amounts that they will receive or pay. The DFS will automatically add onto the courier's pricing any commissions prior to evaluating the bid against any reserve pricing or displaying this to the merchant.

Let the price paid by the merchant be $M and the price received by the courier be $C. Further let the commissions on the merchant be %M and %C for the courier, then

$$\$ M = \$ C \times \frac{( 1 + \% C )}{( 1 - \% M )}$$

It is important to note that while a merchant commission will be constant for a given job, the courier commission may vary between competing couriers. Consequently the “best bid” price displayed to couriers during a live auction is actually the price they must beat rather than the price bid by the competing courier. The difference is attributable to (potentially) different courier commission rates.

2.5.3 Payment Aggregation

To minimise the transaction costs associated with collecting payments from merchants and paying couriers, aggregation accounts shall be maintained for each merchant and courier. The payments due from each job will be credited to each aggregation account which shall be settled periodically or when it exceeds some threshold. The period between settlement and the dollar threshold before settlement shall be configurable individually for each courier and merchant.

2.5.4 Commission

The commission for each job shall be defined as a percentage of both the nominal courier fee plus a percentage of the nominal merchant fee according to the following formula.

Let the price received by the Courier be $C. Further let the commissions on the merchant be %M and %C for the courier, then

$$Commission = \$ C \times \frac{( \% C + \% M )}{( 1 - \% M )}$$

2.5.5 Courier Bonds

Couriers may be required to lodge a bond equal to the total amount of goods that they may be delivering at any given time. Under this example, couriers will only be able to bid for jobs if the value of those goods is less than the amount of the bond less any jobs that they have already won but not as yet completed. A minimum bond level will also apply and if the couriers aggregate bond falls to a level less than this amount, then the courier will not be offered any jobs regardless of their value.

In the event of a failure to deliver goods, including a failure to notify DFS that the goods have been delivered in the required timeframe, then the DFS shall deduct an amount equal to the value of the goods from the bond. This amount will be held in trust until the non-delivery is resolved and then either returned to the bond account if the goods have subsequently been delivered or returned to the merchant, or given to the merchant as compensation for the lost goods.

The system administrator, in the case of couriers with suitable credit credentials, may waive the need for a bond to be lodged by the courier.

### 2.6 Courier Failures

In the vent that a courier fails to act in accordance with their declared intent, such as:
failing to acknowledge/accept a job for which they were the successful bidder,
failing to pickup the goods for delivery,
failing to deliver the goods, or
failing to notify delivery of goods within the required delivery window,

then a penalty payment shall be deducted from any moneys owed to the courier. These penalties shall be variable depending on the failure type and as set by the DFS administrator. In the event that the courier has no moneys owing, then the amount of the penalty will be deducted from the couriers bond.

To assist the DFS administrators in identifying unreliable couriers, a failure history report will be generated whenever a courier failure is identified. This report will show a date history of other failures and give sufficient information to allow the administrator to make a value judgment of the offending courier, and access whether or not suspension of the courier from the system for some period is appropriate.

### 2.7 Security

All couriers, merchants and jobs will be identified by a unique numerical identifier, which together with passwords will be used to control access to the system and for system reporting. This number will be incorporated on physical identification collateral to allow users to uniquely identify other agents of the system. The use of numerical identifiers will support automated phone access by the DFS by its users.

### 2.8 Transaction Records

All transactions stored in database and able to be interrogated by administrator.

What is claimed:

1. A method of matching a sender to a courier, in a networked environment, comprising the steps of:
accepting from each of a group of eligible couriers, in respect of a delivery, a standing offer;
accepting from a sender, a job specification and a reserve price;
comparing the job specification and the reserve price with the standing offers to determine whether or not the reserve price for the job specification is met by at least one of the standing offers, and, in the event that the reserve price is met by at least one of the standing offers, presenting to the sender the lowest standing offer of at least one courier, and, in the event that the reserve price for the job specification is not met by at least one of the standing offers, initiating at the senders request, a live reverse auction between eligible couriers, accepting bids from any of the eligible couriers, and notifying the sender of a winning bid.

2. The method of claim 1, wherein:
the winning bid is the second lowest bid.

3. A method of matching a seller to a buyer, in a networked environment, comprising the steps of:
accepting from each of a group of potential sellers, in respect of goods or services, a standing offer;
receiving from a buyer an order for one or more of the goods and services, the order including a reserve price;
comparing the order and the reserve price with the standing offers to determine whether or not the reserve price for the order is met by at least one of the standing offers, and, in the event that the reserve price is met by at least one of the standing offers, presenting to the buyer the lowest offer of at least one seller, and, in the event that the reserve price for the order is not met by at least one of the standing offers, initiating at the buyers request, a live reverse auction between the potential sellers, accepting bids from any of the eligible sellers, and notifying the buyer of a winning bid.

4. The method of claim 3, wherein:
the winning bid is the second lowest bid.
